(19) United States
(12) Patent Application Publication
(10) Pub. No.: US 2005/0231664 A1
(43) Pub. Date: Oct. 20, 2005

(54) Transflective liquid crystal display

(75) Inventors: Chiu-Lien Yang, Miao-Li (TW); Chueh-Ju Chen, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/111,074

(22) Filed: Apr. 20, 2005

(30) Foreign Application Priority Data
Apr. 20, 2004 (TW) 93110947

(51) Int. Cl. G02F 1/1335

(52) U.S. Cl. 349/113

(57) ABSTRACT

A transflective liquid crystal display (2) has a first substrate (21), a second substrate (210) opposite to the first substrate, an alignment means (23, 231) provided on respective opposing surface of the first and second substrates, and a liquid crystal layer (20) sandwiched between the first and second substrates. The liquid crystal molecules of the liquid crystal layer have two different orientations respectively corresponding to a transmission display region (20a) and a reflection display region (20b). Furthermore, the transflective liquid crystal display has two different thicknesses respectively corresponding to the reflection region and the transmission region.

### BACKGROUND OF THE INVENTION

1. Field of the Invention

The present invention relates to a transflective liquid crystal display (LCD), and particularly to a transflective LCD with a so-called hybrid bend.

2. General Background

Typically, Cathode Ray Tubes (CRT), Electroluminescence (EL) elements, Plasma Display Panels (PDPs) etc. have been put into practical use as displays of the light emissive type in which display contents can be overwritten electrically.

However, since these types of displays emit display light and use the same directly for the display, they have high power consumption. Further, the light-emitting surface of these types of display serves as a display surface having high reflectance. Therefore if the display is used under circumstances where ambient light is brighter than the luminance (for example, in direct sunlight), then a phenomenon known as “wash-out” invariably occurs, and the display light cannot be easily observed.

On the other hand, liquid crystal displays have been put into practical use which display characters and/or images by using a background light source rather than by emitting a display light. These liquid crystal displays include a transmission type and a reflection type.

Of the two types of liquid crystal displays, the transmission type, which employs a light source called a “backlight” behind the liquid crystal cell, is particularly popular. Since the liquid crystal displays of the transmission type are advantageous due to their thinness and lightness, they have been used in numerous, diverse fields. On the other hand, liquid crystal displays of the transmission type consume a large amount of power to keep the backlight on. Thus, even though only a small amount of power is consumed to adjust transmittance of the liquid crystals, a relatively large amount of power is consumed overall.

However, the liquid crystal displays of the transmission type wash out less frequently compared with the displays of the light emissive type. In particular, in the case of color liquid crystal displays of the transmission type, the reflectance on the display surface of a color filter layer is reduced by reflectance reducing means such as a black matrix.

Nevertheless, it becomes too difficult to readily observe the display light on color liquid crystal displays of the transmission type when they are used under the circumstances where the ambient light is very strong and the display light is relatively weak. This problem can be eliminated by using a brighter backlight, but this solution further increases power consumption.

Unlike the displays of the light emissive type and liquid crystal displays of the transmission type, the liquid crystal displays of the reflection type show the display using the ambient light, thereby obtaining a display light proportional to the amount of ambient light. Thus, the liquid crystal display of the reflection type are advantageous insofar as they do not wash out. When used in a very bright place in direct sunlight, for example, the display can be observed all the more sharply. Further, the reflection type liquid crystal display does not use a backlight for the display, and therefore has the further advantage of low power consumption. For the above reasons, the LCD of the reflection type are particularly suitable as the devices for outdoor use, such as portable information terminals, digital cameras, and portable video cameras.

However, since reflection type liquid crystal displays use ambient light for the display, the display luminance largely depends on the surrounding environment. When the ambient light is weak, the display content cannot be easily observed. In particular, in the case where a color filter is used for realizing the color display, the color filter absorbs the light and the display becomes darker. Thus, when used under these circumstances, the ambient light problem is even more pronounced.

On the other hand, another LCD which transmits a part of incident light and reflects the rest, have been put into practical use as the LCD which can be used under the circumstances where the ambient light is weak while maintaining the advantages of the LCD of the reflection type. The LCD using both the transmitted light and reflected light are generally referred to as the LCD of the transflective type.

Current transflective LCDs use twisted nematic (TN) or mixed-mode twisted nematic (MTN). However, the optical properties are not good for transmissive and reflective optical properties. Another drawback of slow response causes TN and MTN LCD cannot be used for moving pictures. For further market demand, the function with moving picture inside LCD is essential.

For possessing fast optical response, optical compensated bend (OCB) mode is provided in the transflective LCD. However the bend state is not stable at low voltage. It takes a long warm-up time before working the LCD and there are domains emerge between pixels to damage the image quality.

Therefore, what is needed is a new mode for transflective LCD which can overcome the above-described problems.

### SUMMARY

In one embodiment, a transflective liquid crystal display has a first substrate, a second substrate opposite to the first substrate, an alignment means provided on respective opposing surface of the first and second substrates, and a liquid crystal layer sandwiched between the first and second substrates. The liquid crystal molecules of the liquid crystal layer have two different orientations respectively corresponding to a transmission display region and a reflection display region. Furthermore, the transflective liquid crystal display has two different thicknesses respectively corresponding to the reflection region and the transmission region.

The LCD has different thickness in the reflection display region and transmission region, i.e. double cell gap, which can utilize the optical characterization of transmission and reflection at the same time to enhance the utilization ratio of light beams, corresponding to the LCD with a single cell gap. Furthermore, the LCD has a hybrid-bend liquid crystal profile, that is the orientation of the liquid crystal of the present LCD is substantially different, in the reflection display region and the transmission display region. Therefore, the LCD possesses fast optical response for true video rate, such as for TV applications, motion pictures, fast electro optical devices. By using the large tilt angle of the reflection region and the small tilt angle of the transmission region and the continuous elastic deformation between the liquid crystal molecular, the LCD overcomes the long splay-to-bend state transition time and unstable state.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, side cross-sectional view of a transflective LCD in accordance with the first embodiment of the present invention;

FIG. 2 is a schematic, essential optical path view of the transflective LCD of FIG. 1; and

FIG. 3 is a schematic, side cross-sectional view of a transflective LCD in accordance with a second embodiment of the present invention.

### DETAILED DESCRIPTION OF THE PREFERRED EMBODIMENTS

Hereinafter, preferred embodiments of the present invention will be explained in detail with reference to the accompanying drawings.

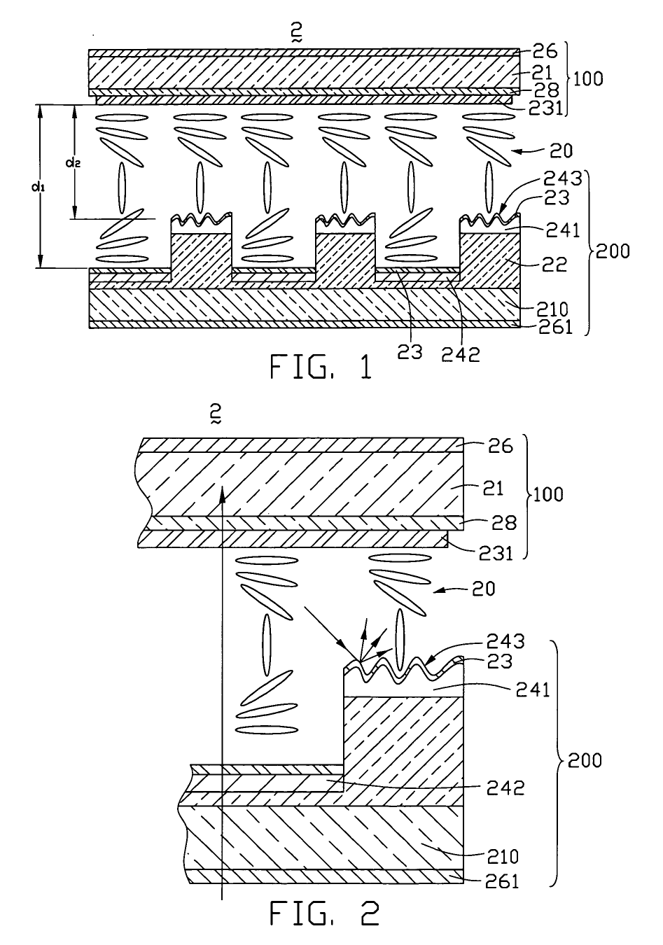

FIG. 1 shows a cross-section of a portion of a transflective LCD 2 according to the first embodiment of the present invention. The transflective LCD 2 includes a first electrode substrate 100, a second electrode substrate 200 opposite to the first electrode substrate 100, and a liquid crystal layer 20 sandwiched between the first electrode substrate 100 and the second electrode substrate 200. The first electrode substrate 100 includes an alignment film 231, which contacts the liquid crystal layer 20. That is, the alignment film 231 serves as an interface between the first electrode substrate 100 and the liquid crystal layer 20. Rubbing treatment has been applied to the alignment film 231, so that the alignment film 231 provides a tilt angle of less than 10 degrees. The second electrode substrate 200 includes an alignment film 23, which contacts the liquid crystal layer 20. That is, the alignment film 23 serves as an interface between the second electrode substrate 200 and the liquid crystal layer 20. Rubbing treatment has been applied to the alignment film 23. The first and second electrode substrates 100, 200 include two polarizers 26, 261 at outsides thereof respectively. Polarizing axis of the polarizers 26, 261 are perpendicular to each other.

The first electrode substrate 100 also includes a substrate 21, which may, for example, be a light transmitting glass substrate. A common electrode 28 (voltage applying means) is formed on an underside of the substrate 21, for applying a voltage to the liquid crystal layer 20. The common electrode 28 is covered by the alignment film 231.

The second electrode substrate 200 is provided in such a manner as to oppose the first electrode substrate 100 through the liquid crystal layer 20. The second electrode substrate 200 also includes a light transmitting substrate 210. An insulation film 22 is formed on the substrate 210. Transmissive counter electrodes 242 (voltage applying means) and reflective counter electrodes 241 (voltage applying means) are formed on the insulation film 22. The counter electrodes 242, 241 generally oppose the common electrode 28 across the liquid crystal layer 20, so that a voltage can be applied to the liquid crystal layer 20.

The insulation film 22 is made in such a manner as to have different thicknesses in regions corresponding to regions of the liquid crystal layer 20 used for display. With such configuration, regions of the liquid crystal layer 20 used for display have at least two different thicknesses. In the illustrated embodiment, such regions of the liquid crystal layer 20 have two different thicknesses. More specifically, the insulation film 22 is thin in each of regions corresponding to each of transmission display regions 20a, and the insulation film 22 is thick in each of regions corresponding to each of reflection display regions 20b. That is, a thickness d1 of the liquid crystal layer 20 corresponding to each transmission display region 20a is greater than a thickness d2 of the liquid crystal layer 20 corresponding to each reflection display region 20b. More particularly, the thicknesses d1, d2 satisfy the formula: 1/4d1≦d2≦7/8d1.

In each region of the second electrode substrate 200 corresponding to each reflection display region 20b, the reflective counter electrodes 241 have a highly uneven surface 243. In addition, because rubbing treatment has been applied to the covering alignment film 23, the alignment film 23 provides a tilt angle between 50 and 90 degrees.

In each region of the second electrode substrate 200 corresponding to each transmission display region 20a, because rubbing treatment has been applied to the alignment film 23 covering the transmissive counter electrode 242, the alignment film 23 provides a tilt angle less than 10 degrees.

The common electrode 28 and the transmissive counter electrodes 242 are transparent electrodes which may be made, for example, of Indium Tin Oxide (ITO). The reflective counter electrodes 241 have light reflecting properties, and may be made, for example, of aluminum, silver, or another suitable material. A voltage is applied to the electrodes 28, 242, 241 in order to apply an electric field in the liquid crystal layer 20. Thus, the content of the display is controlled by the voltage applied to the liquid crystal layer 20.

A passive state of the LCD 2 is described as follows. In each transmission display region 20a, liquid crystal molecules of the liquid crystal layer 20 which are adjacent to the alignment films 231, 23 of the electrode substrates 100, 200 are substantially parallel to the electrode substrates 100, 200, due to the alignment films 23, 231 having the low tilt angle of less than 10 degrees. In each reflection display region 20b, the liquid crystal molecules of the liquid crystal layer 20 which are adjacent to the alignment film 231 of the first electrode substrate 100 are substantially parallel to the first electrode substrate 100, due to the alignment film 231 having the low tilt angle of less than 10 degrees. The liquid crystal molecules of the liquid crystal layer 20 which are adjacent to the alignment film 23 of the second electrode substrate 200 are substantially perpendicular to the second electrode substrate 200, due to the alignment film 23 having the high tilt angle of between 50 degrees and 90 degrees. Therefore, it can be said that the LCD 2 has a hybrid-bend liquid crystal profile.

Referring to FIG. 2, the reflection display region 20b has the reflective counter electrode 241. Ambient light incident on the display enters the LCD 2 from the side of the first electrode substrate 100, and is reflected by the reflective counter electrode 241 back toward the display. By applying the electric field and changing the orientations of the liquid crystal molecules, the reflection luminance can be controlled. The transmission display region 20a has the transmissive counter electrode 242. Backlight enters the LCD 2 from the side of the second electrode substrate 200, and passes through the transmissive counter electrode 242 toward the display. By applying the electric field and changing the orientations of the liquid crystal molecules, the transmission luminance can be controlled.

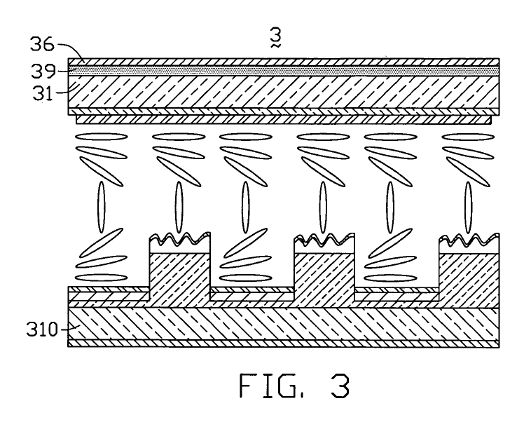

Referring to FIG. 3, a transflective LCD 3 according to the second embodiment of the present invention has a structure similar to that of the LCD 2 of the first embodiment. The LCD 3 includes an optical compensation film 39 between a top substrate 31 and a polarizer 36. The compensation film 39 can be a biaxial film or a discostic liquid crystal film. Further or alternatively, a compensation film 39 can be provided on a bottom substrate 310.

The advantages of the above-described embodiments are summarized in relation to the LCD 2 as follows. Firstly, the liquid crystal layer 20 of the LCD 2 has different thickness in the reflection display regions 20b and transmission display regions 20a. That is, the LCD 2 has a so-called double cell gap, and can therefore utilize the optical characteristics of transmission and reflection at the same time to enhance the utilization ratio of light beams. This is most advantageous compared to a conventional LCD that has a so-called single cell gap. Secondly, the LCD 2 has the hybrid-bend liquid crystal profile, with the orientations of the liquid crystal molecules the reflection display regions 20b and the transmission display regions 20a being substantially different. By utilizing the large tilt angle of the reflection display regions 20b and the small tilt angle of the transmission display regions 20a and the continuous elastic deformation between the liquid crystal molecules, the LCD 2 overcomes the long splay-to-bend state transition times and instability of a conventional LCD. Therefore the LCD 2 has fast optical response characteristics suitable for video displays in applications such as TVs, motion pictures, and high-speed electro-optical devices. Thirdly, the reflective counter electrodes 241 have the uneven surfaces 243, which diffuse ambient light beams impinging thereon and eliminate the mirror-reflection. This further enhances the performance of the display.

It is to be understood, however, that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display comprising:
a pair of substrates;
a liquid crystal layer sandwiched between the substrates, the liquid crystal layer comprising liquid crystal molecules;
two alignment means provided at respective opposing surfaces of the substrates, one of the alignment means simultaneously providing two different orientations of liquid crystal molecules in different display regions used for reflection display regions for showing reflection display and transmission display regions for showing transmission display respectively; and
reflection means provided between the alignment means and the substrate correspond to the reflection display regions.

2. The liquid crystal display of claim 1, wherein said one of the alignment means provides two different tilt angles for liquid crystal molecules.

3. The liquid crystal display of claim 2, wherein a first one of the tilt angles is between 50 degrees and 90 degrees, and a second one of the tilt angles is less than 10 degrees.

4. The liquid crystal display of claim 3, wherein the first tilt angle corresponds to the reflection display regions, and the second tilt angle corresponds to the transmission display regions.

5. The liquid crystal display of claim 1, wherein the other alignment means provides a single orientation for liquid crystal molecules.

6. The liquid crystal display of claim 5, wherein the other alignment means provides a single tilt angle for liquid crystal molecules.

7. The liquid crystal display of claim 6, wherein the title angle of the other alignment means is less than 10 degrees.

8. The liquid crystal display of claim 1, wherein the liquid crystal layer has two different thicknesses corresponding to the reflection regions and the transmission regions, with the thicker parts of the liquid crystal layer corresponding to the transmission regions, and the thinner parts of the liquid crystal layer corresponding to the reflection regions.

9. The liquid crystal display of claim 1, further comprising transmission means provided at parts of said one of the alignment means that correspond to the transmission display regions.

10. The liquid crystal display of claim 1, wherein the reflection means has an uneven surface facing the liquid crystal layer.

11. The liquid crystal display of claim 1, further comprising an optical compensation film provided at at least one of the substrates.

12. The liquid crystal display of claim 11, wherein the optical compensation film is a biaxial film or a discostic liquid crystal film.

13. A transflective liquid crystal display comprising:
a first substrate;
a second substrate opposite to the first substrate;
an alignment means provided on respective opposing surfaces of the first and second substrates; and
a liquid crystal layer sandwiched between the first and second substrates, liquid crystal molecules of the liquid crystal layer having two different orientations respectively corresponding to a transmission display region and a reflection display region.

14. The transflective liquid crystal display of claim 13, wherein liquid crystal molecules of the transmission region that are adjacent to the first and second substrates are substantially parallel to the opposing surfaces of the first and second substrates respectively.

15. The transflective liquid crystal display of claim 14, wherein liquid crystal molecules of the reflection region that are adjacent to the first substrate are substantially parallel to the surface of the first substrate.

16. The transflective liquid crystal display of claim 15, wherein liquid crystal molecules of the reflection region that are adjacent to the second substrate are substantially perpendicular to the surface of the first substrate.

17. The liquid crystal display of claim 13, wherein the liquid crystal layer has two different thicknesses corresponding to the reflection region and the transmission region, with the thicker part of liquid crystal layer corresponding to the transmission region, and the thinner part of liquid crystal layer corresponding to the reflection region.

18. A transflective liquid crystal display comprising:
a first substrate;
a second substrate opposite to the first substrate;
an alignment means provided on at least one of two opposing surfaces of the first and second substrates; and
a liquid crystal layer sandwiched between the first and second substrates, liquid crystal molecules of the liquid crystal layer having two different orientations respectively corresponding to a transmission display region and a reflection display region; wherein
the reflection display region is provided with an uneven surface for better diffusion.

19. The display as claimed in claim 18, wherein said a thickness of the transmission display region is different from that of the reflection display region.

20. The display as claimed in claim 18, wherein a tilt angle of the reflection display region is larger than that of the transmission display region.
